(19) United States
(12) Patent Application Publication
(10) Pub. No.: US 2014/0215273 A1
(43) Pub. Date: Jul. 31, 2014

(54) VOLTAGE TESTING DEVICE AND METHOD FOR CPU

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: MING YU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/056,260

(22) Filed: Oct. 17, 2013

(30) Foreign Application Priority Data
Jan. 30, 2013 (CN) 2013100354641

(51) Int. Cl. G06F 11/26

(52) U.S. Cl. CPC G06F 11/26
USPC 714/37

(57) ABSTRACT

The disclosure provides a voltage testing device and a method. A voltage testing device includes a PCB, a digital switch, and a detecting chip. The PCB includes a CPU socket, a signal producing chip, and a voltage regulator connected to the CPU socket. The digital switch sets predetermined data. The detecting chip is inserted in the CPU socket. The detecting chip includes a reading module, a converting module, a sending module, and a control module. The signal producing chip sends a start-up signal to the control module. The converting module coverts the predetermined data to SVID data. The sending module sends the SVID data to the voltage regulator. The voltage regulator sends a CPU voltage to the CPU socket. The voltage value testing device calculates a value of the CPU voltage to determined if the value of the CPU voltage associates with a voltage corresponding to the predetermined data.

### BACKGROUND

1. Technical Field

The present disclosure generally relates to a voltage testing device and method for a central processing unit (CPU).

2. Description of Related Art

CPU of a server sends a subsystem vendor ID (SVID) data to a voltage regulator when the server is powered on. The voltage regulator sends a voltage to the inner core of the CPU to supply power for the inner core according to the SVID data. However, the voltage regulator may send a voltage with a high value to the inner core to burn out the CPU when there is something wrong with the voltage regulator.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a voltage testing device.

FIG. 2 is a flow chart of one embodiment of a voltage testing method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

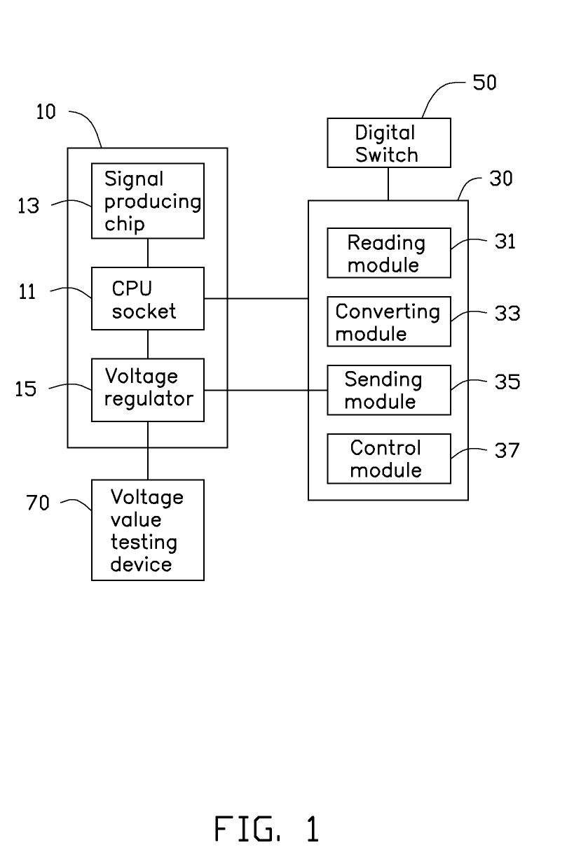

FIG. 1 shows a voltage testing device according to one embodiment. The voltage testing device includes a printed circuit board 10. The printer circuit board 10 includes a CPU socket 11, a signal producing chip 13 connected to the CPU socket 11, and a voltage regulator 15 connected to the CPU socket 11. The voltage testing device further includes a detecting chip 30 inserted in the CPU socket 11 and a digital switch 50 connected to the detecting chip 30. The voltage testing device further includes a voltage value testing device 70 for calculating the voltage value of the voltage output from the voltage regulator 15 to the CPU socket 11. In one embodiment, the signal producing chip 13 is a south bridge chip, and the voltage testing device 70 is an oscillograph.

The detecting chip 30 includes a reading module 31 connected to the digital switch 50, a converting module 33 connected to the reading module 31, a sending module 35 connected to the converting module 33, and a control module 37 connected to the reading module 31. The sending module 35 is connected to the voltage regulator 15.

The digital switch 50 is configured to set predetermined data. In the illustrated embodiment, the predetermined data is 8 bit binary data, such as 10000001.

The signal producing chip 13 of the printed circuit board 10 sends a start-up signal to the control module 37 when the printed circuit board 10 is triggered to be powered on. The control module 37 of the detecting chip 30 controls the reading module 31 to read the predetermined data of the digital switch and sends the predetermined data to the converting module 33. The converting module 33 coverts the predetermined data to SVID data according to the SVID bus protocol and sends the SVID data to the voltage regulator 15. The voltage regulator 15 sends a CPU voltage to the CPU socket 11 according to the SVID data. The voltage value testing device 70 calculates the value of the CPU voltage. If the value of the CPU voltage associates with the voltage corresponding to the predetermined data, the detecting chip 30 can be replaced with a CPU for the server to be powered on normally. If not, the CPU voltage is judged to be abnormal.

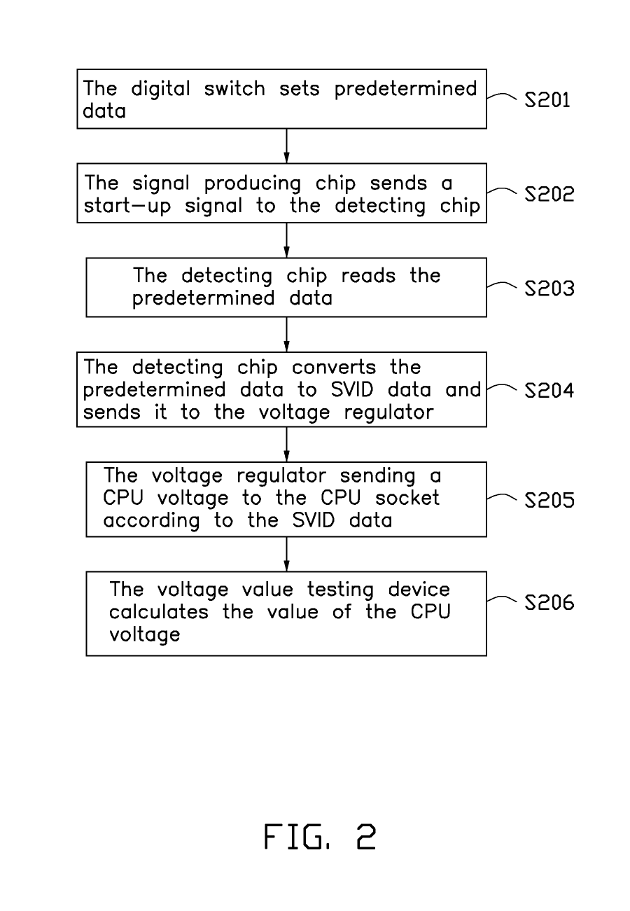

FIG. 2 shows that a voltage testing method includes following steps.

S201, the digital switch 50 sets a predetermined data.

S202, the signal producing chip 13 sends a start-up signal to the control module 37 of the detecting chip 30 when the printed circuit board 10 is triggered to be powered on.

S203, the control module 37 controls the reading module 31 to read the predetermined data of the digital switch 50 and sends the predetermined data to the converting module 33.

S204, the converting module 33 coverts the predetermined data to SVID data according to the SVID bus protocol and sends the SVID data to the voltage regulator 15.

S205, the voltage regulator 15 sends a CPU voltage to the CPU socket 11 according to the SVID data.

S206, the voltage value testing device 70 calculates the value of the CPU voltage to determined if the value of the CPU voltage associates with the voltage corresponding to the predetermined data.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A voltage testing device comprising:
a printed circuit board, the printed circuit board comprising a CPU socket, a signal producing chip connected to the CPU socket, and a voltage regulator connected to the CPU socket;
a voltage value testing device;
a digital switch, the digital switch is configured to set predetermined data; and
a detecting chip connected to the digital switch , the detecting chip inserted in the CPU socket; the detecting chip comprising a reading module connected to the digital switch, a converting module, a sending module, and a control module;
wherein the signal producing chip is configured to send a start-up signal to the control module after the printed circuit board is triggered to be powered on; the control module is configured to control the reading module to read the predetermined data; the converting module is configured to covert the predetermined data to SVID data; the sending module is configured to send the SVID data to the voltage regulator; the voltage regulator is configured to send a CPU voltage to the CPU socket according to the SVID data; and the voltage value testing device is configured to calculate a value of the CPU voltage to determined if the value of the CPU voltage associates with a voltage corresponding to the predetermined data.

2. The voltage testing device of claim 1, wherein the predetermined data is 8 bit binary data.

3. The voltage testing device of claim 1, wherein the signal producing chip is a south bridge chip.

4. The voltage testing device of claim 1, wherein the voltage value testing device is an oscillograph.

5. A voltage testing method comprising:
providing a voltage testing device, the voltage testing device comprising a printed circuit board, a voltage value testing device, a digital switch, a detecting chip connected to the digital switch, and a voltage value testing device; the printed circuit board comprising a CPU socket, a signal producing chip, and a voltage regulator connected to the CPU socket;
setting a predetermined data by the digital switch;
sending a start-up signal to the detecting chip by the signal producing chip after the printed circuit board is triggered to be powered on;
converting the predetermined data to SVID data and sending the SVID data to the voltage regulator by the detecting chip;
sending a CPU voltage to the CPU socket according to the SVID data by the voltage regulator; and
calculating a value of the CPU voltage by the voltage value testing device to determine if the value of the CPU voltage associates with a voltage corresponding to the predetermined data.

6. The voltage testing method of claim 5, wherein the predetermined data is 8 bit binary data.

7. The voltage testing method of claim 5, wherein the signal producing chip is a south bridge chip.

8. The voltage testing method of claim 5, wherein the voltage value testing device is an oscillograph.
